(19) United States
(12) Patent Application Publication
(10) Pub. No.: US 2025/0072687 A1
(43) Pub. Date: Mar. 6, 2025

(54) CONTROL METHOD AND APPARATUS FOR CLEANING ASSEMBLY, CLEANING ASSEMBLY, AND MEDIUM

(71) Applicant: Wuxi Little Swan Electric Co., Ltd., Wuxi (CN)

(72) Inventors: Weiguo YANG, Wuxi (CN); Zhiwei ZHANG, Wuxi (CN); Yuqing WANG, Wuxi (CN)

(21) Appl. No.: 18/293,948

(22) PCT Filed: Jul. 25, 2023
(86) PCT No.: PCT/CN2023/109105

§ 371 Date: Jan. 31, 2024

(30) Foreign Application Priority Data
Mar. 3, 2023 (CN) 202310196073.1

(51) Int. Cl. A47L 11/40; A47L 11/24; D06F 29/00; D06F 39/08; D06F 103/14; D06F 105/02; G05D 9/12

(52) U.S. Cl. CPC A47L 11/4011; A47L 11/24; A47L 11/4083; A47L 11/4091; D06F 29/00; D06F 39/087; D06F 39/088; G05D 9/12; A47L 2201/026; A47L 2201/028; D06F 2103/14; D06F 2105/02

(57) ABSTRACT

A control apparatus includes obtaining and control modules. The obtaining module is configured to obtain a water feeding request for each of at least one of two components of a cleaning assembly. The two components include floor cleaning and clothes cleaning components. The floor cleaning component includes a base station water tank, a movable member water tank, and a base station washing tank. The control module is configured to determine that one component is in a water feeding state, and control water feeding to another component based on a water feeding request for the component, including, in response to the one component being the clothes cleaning component, controlling water feeding to the floor cleaning component based on a water feeding request for the floor cleaning component, including controlling the base station water tank to feed water to the movable member water tank and/or to the base station washing tank.

This application claims priority to Chinese Patent Application No. 202310196073.1, titled “CONTROL METHOD AND APPARATUS FOR CLEANING ASSEMBLY, CLEANING ASSEMBLY, AND MEDIUM,” and filed with China National Intellectual Property Administration on Mar. 3, 2023, the entire disclosure of which is incorporated herein by reference.

### FIELD

The present disclosure relates to the field of home appliance technologies, and more particularly, to a control method and apparatus for a cleaning assembly, a cleaning assembly, and a medium.

### BACKGROUND

People purchase cleaning appliances that meet different cleaning needs based on their cleaning demands. For example, washing machines, vacuum cleaners, and the like have been widely used in households. However, a space available for arranging the cleaning appliances in home is often limited. Therefore, two cleaning appliances having the same or different functions may be integrated into a limited space, forming a cleaning assembly. Various cleaning components of the cleaning assembly can share water and electricity, and thus the space can be saved.

### SUMMARY

In view of this, embodiments of the present disclosure provide a control method and apparatus for a cleaning assembly, a cleaning assembly, and a medium, which can improve operating efficiency of the cleaning assembly.

According to embodiments in a first aspect of the present disclosure, there is provided a control method for a cleaning assembly. The control method includes: obtaining a water feeding request for at least one component of the cleaning assembly, in which the cleaning assembly includes two components including a floor cleaning component and a clothes cleaning component; and determining that one of the two components of the cleaning assembly is in a water feeding state, and controlling water feeding to another one of the two components of the cleaning assembly based on a water feeding request for the other one of the two components. The floor cleaning component includes a base station water tank, a movable member water tank, and a base station washing tank. The determining that the clothes cleaning component is in the water feeding state, and controlling water feeding to the floor cleaning component based on a water feeding request for the floor cleaning component includes: controlling the base station water tank of the floor cleaning component to feed water to the movable member water tank; and/or controlling the base station water tank of the floor cleaning component to feed water to the base station washing tank.

In some embodiments of the present disclosure, the two components of the cleaning assembly includes a first component and a second component, and each of the first component and the second component includes a water inlet valve. The determining that the first component is in the water feeding state, and controlling water feeding to the second component based on a water feeding request for the second component includes: determining that the first component is in the water feeding state, and based on the water feeding request for the second component, controlling the water inlet valve of the first component to open to feed water to the first component through a first passage of a three-way passage structure, and controlling the water inlet valve of the second component to open to feed water to the second component through a second passage of the three-way passage structure.

In some embodiments of the present disclosure, the controlling the water inlet valve of the first component to open includes: controlling the water inlet valve of the first component to open, and adjusting an opening degree of the water inlet valve of the first component to control a flow rate of water fed to the first component; and the controlling the water inlet valve of the second component to open includes: controlling the water inlet valve of the second component to open, and adjusting an opening degree of the water inlet valve of the second component to control a flow rate of water fed to the second component.

In some embodiments of the present disclosure, the controlling the base station water tank of the floor cleaning component to feed water to the movable member water tank; and/or the controlling the base station water tank of the floor cleaning component to feed water to the base station washing tank further include: controlling water fed to the base station water tank of the floor cleaning component to reach a first threshold.

In some embodiments of the present disclosure, the floor cleaning component further includes a movable member water suction pump. The controlling the base station water tank of the floor cleaning component to feed water to the movable member water tank includes: controlling the movable member water suction pump to open, and feeding water to the movable member water tank by the movable member water suction pump.

In some embodiments of the present disclosure, the floor cleaning component further includes a base station water pump. The controlling the base station water tank of the floor cleaning component to feed water to the base station washing tank includes: controlling the base station water pump to open, and feeding water to the base station washing tank by the base station water pump.

In some embodiments of the present disclosure, the control method further includes, subsequent to the controlling water fed to the base station water tank of the floor cleaning component to reach the first threshold: stopping the water feeding to the floor cleaning component; obtaining a current water volume of the base station water tank of the floor cleaning component; and feeding water to the base station water tank in response to determining that the current water volume is smaller than a second threshold. The second threshold is smaller than or equal to the first threshold.

According to embodiments in a second aspect of the present disclosure, there is provided a control apparatus for a cleaning assembly. The control apparatus includes: an obtaining module configured to obtain a water feeding request for at least one component of the cleaning assembly, in which the cleaning assembly includes two components including a floor cleaning component and a clothes cleaning component; a control module configured to determine that one of the two components of the cleaning assembly is in a water feeding state, and control water feeding to another one of the two components of the cleaning assembly based on a water feeding request for the other one of the two components. The floor cleaning component includes a base station water tank, a movable member water tank, and a base station washing tank; and the control module is further configured to: determine that the clothes cleaning component is in the water feeding state; and based on a water feeding request for the floor cleaning component, control the base station water tank of the floor cleaning component to feed water to the movable member water tank, and/or control the base station water tank of the floor cleaning component to feed water to the base station washing tank.

According to embodiments in a third aspect of the present disclosure, there is provided a cleaning assembly. The cleaning assembly includes a memory, a processor, and a computer program stored on the memory and executable on the processor. The processor is configured to implement, when executing the computer program, the control method according to the above embodiments of the present disclosure.

According to embodiments in a fourth aspect of the present disclosure, there is provided a computer-readable storage medium. The computer-readable storage medium has computer-readable instructions stored thereon. The computer-readable instructions implement, when executed by a processor, the control method according to the above embodiments of the present disclosure.

The technical solution according to the embodiments of the present disclosure has the following advantages over the related art.

The control method for the cleaning assembly according to the embodiments of the present disclosure includes: obtaining a water feeding request for at least one component of the cleaning assembly, in which the cleaning assembly includes two components includes a floor cleaning component and a clothes cleaning component; and determining that one of the two components of the cleaning assembly is in a water feeding state, and controlling water feeding to another one of the two components of the cleaning assembly based on a water feeding request for the other one of the two components. Further, the floor cleaning component includes a base station water tank, a movable member water tank, and a base station washing tank. The determining that the clothes cleaning component is in the water feeding state, and controlling water feeding to the floor cleaning component based on a water feeding request for the floor cleaning component includes: controlling the base station water tank of the floor cleaning component to feed water to the movable member water tank; and/or controlling the base station water tank of the floor cleaning component to feed water to the base station washing tank. Therefore, in the embodiments of the present disclosure, the floor cleaning component and the clothes cleaning component are integrated into the cleaning assembly. When one of the two components of the cleaning assembly is in the water feeding state and the water feeding to the other one of the two components of cleaning assembly is needed, the two components of the cleaning assembly can be controlled to be fed with water simultaneously without affecting normal water feeding to either component. In addition, in the embodiments of the present disclosure, water feeding to the two components can be carried out simultaneously when the water feeding to each of the two components of the cleaning assembly is needed. In this way, unlike methods in the related art, it is not necessary to control the water feeding to one component after the water feeding has been carried out on the other component. Therefore, with the control method for the cleaning assembly according to the embodiments of the present disclosure, when the water feeding to each of the two components of the cleaning assembly is needed, an overall water feeding time can be shortened, thereby improving operating efficiency of the cleaning assembly.

### BRIEF DESCRIPTION OF THE DRAWINGS

The drawings herein, which are incorporated into and form a part of the specification, illustrate embodiments consistent with the present disclosure and are used in conjunction with the specification to explain the principles of the present disclosure.

In order to clearly explain technical solutions of embodiments of the present disclosure or in the related art, drawings used in description of the embodiments or the related art will be briefly described below. Based on these drawings, other drawings can be obtained by those skilled in the art without creative effort.

FIG. 1 is a schematic flowchart of a control method for a cleaning assembly according to an embodiment of the present disclosure.

FIG. 2 is a front view of a cleaning assembly according to an embodiment of the present disclosure.

FIG. 3 is a schematic rear structural view of a cleaning assembly according to an embodiment of the present disclosure.

FIG. 4 is a schematic flowchart of a control method for a cleaning assembly according to an embodiment of the present disclosure.

FIG. 5 is a schematic structural diagram of a control apparatus for a cleaning assembly according to an embodiment of the present disclosure.

FIG. 6 is a schematic structural diagram of a cleaning assembly according to an embodiment of the present disclosure.

FIG. 7 is a schematic diagram of a computer-readable storage medium according to an embodiment of the present disclosure.

### DETAILED DESCRIPTION OF THE EMBODIMENTS

In order to more clearly understand the above-mentioned objects, features and advantages of the present disclosure, embodiments of the present disclosure will be further described below. It should be noted that the embodiments of the present disclosure and the features in the embodiments may be combined with each other without conflict.

Many specific details are set forth in the following description in order to facilitate a full understanding of the present application, but the present application may also be implemented in other ways different from those described herein. Obviously, the embodiments in the specification are only a part of the embodiments of the present disclosure and not all of the embodiments.

In the related art, in order to save space, two cleaning appliances having the same or different functions such as a water feeding function and a water drainage function may be arranged in an integrated manner. However, the two cleaning appliances in the integrated arrangement usually cannot be fed water, and it is necessary to wait for one cleaning appliance to finish water feeding before controlling water feeding to another cleaning appliance, resulting in a long time for the water feeding to the integrated cleaning appliance and low operating efficiency. For example, for a dual washing machine in an integrated arrangement, when water feeding to both washing machines is needed, water cannot be fed to one washing machine until water has been fed to the other washing machine, leading to a relatively long water feeding time of the dual washing machine and relatively low operating efficiency.

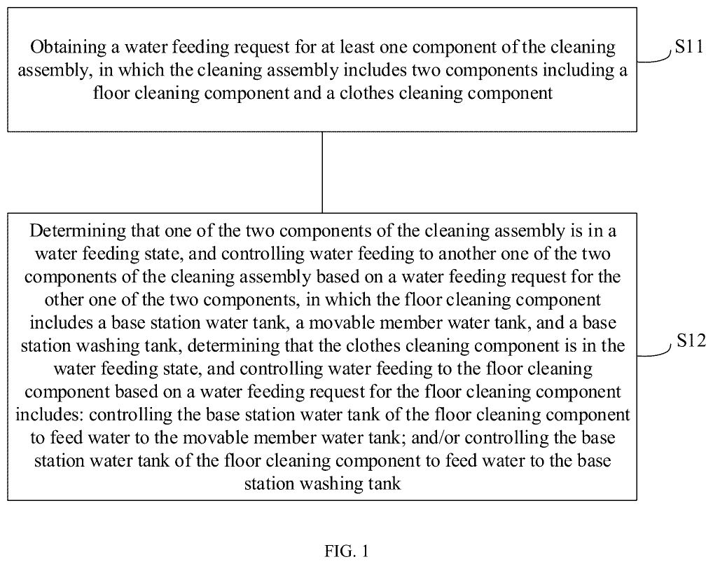

In order to solve the above-mentioned problems, embodiments of the present disclosure provide a control method for a cleaning assembly. FIG. 1 is a schematic flowchart of a control method for a cleaning assembly according to an embodiment of the present disclosure. The control method for the cleaning assembly may be applied to a scenario in which the cleaning assembly needs to be controlled. This method according to the embodiments may be performed by a control apparatus for a cleaning assembly according to an embodiment of the present disclosure, and the control apparatus for the cleaning assembly may be implemented by means of software and/or hardware. As illustrated in FIG. 1, the method includes actions at blocks S11 and S12.

At block S11, a water feeding request for at least one component of the cleaning assembly is obtained. The cleaning assembly includes two components. The two components may include a floor cleaning component such as a mopping machine and a clothes cleaning component such as a washing machine.

The two components of the cleaning assembly may include a first component and a second component. Obtaining the water feeding request for at least one component of the cleaning assembly further includes: obtaining a water feeding request for the first component, or obtaining a water feeding request for the second component, or obtaining a water feeding request for the first component and a water feeding request for the second component simultaneously.

In an exemplary embodiment of the present disclosure, the first component and the second component of the cleaning assembly are both appliances with cleaning needs. The first component may be the floor cleaning component, and the second component may be an appliance with water feeding need such as a clothes cleaning component, a dishwasher, a washer-dryer unit, or the like. In addition, the first component may be an appliance with water feeding need such as a clothes cleaning component, a dishwasher, a washer-dryer unit, or the like, and the second component may be the floor cleaning component, and the present disclosure is not limited thereto. The water feeding request for the first component may be sent by the first component or by a terminal device communicatively connected to the first component, and a sender of the water feeding request for the first component is not limited to the embodiments of the present disclosure. The water feeding request for the second component may be sent by the second component or by a terminal device communicatively connected to the second component, and a sender of the water feeding request for the second component is not limited to the embodiments of the present disclosure.

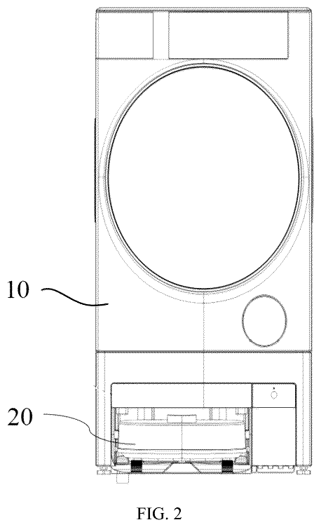

In another exemplary embodiment of the present disclosure, FIG. 2 is a front view of a cleaning assembly according to an embodiment of the present disclosure, in which a clothes cleaning component 10 and a floor cleaning component 20 that are integrated in the cleaning assembly are illustrated. Since each of the two components of the cleaning assembly has a cleaning function, the two components of the cleaning assembly have water feeding need, and water may be fed to the two components of the cleaning assembly by one water circuit. The floor cleaning component 20 is arranged below the clothes cleaning component 10, and therefore a space below the clothes cleaning component 10 can be used to provide a floor space for the floor cleaning component 20, avoiding additional space occupancy by the floor cleaning component 20. In another exemplary embodiment, the clothes cleaning component 10 and the floor cleaning component 20 may be arranged separately, which is not limited to the embodiments of the present disclosure.

At block S12, it is determined that one of the two components of the cleaning assembly is in a water feeding state, and water feeding to another one of the two components of the cleaning assembly is controlled based on a water feeding request for the other one of the two components. The floor cleaning component includes a base station water tank, a movable member water tank, and a base station washing tank. Determining that the clothes cleaning component is in the water feeding state, and controlling water feeding to the floor cleaning component based on a water feeding request for the floor cleaning component includes: controlling the base station water tank of the floor cleaning component to feed water to the movable member water tank; and/or controlling the base station water tank of the floor cleaning component to feed water to the base station washing tank.

In the related art, each of the first component and the second component of the cleaning assembly is for example a clothes cleaning component, and the clothes cleaning component has a large demand for water feeding. When the first component and the second component have a demand for simultaneous water feeding, a water pressure cannot meet needs. In this case, water feeding to the first component is first controlled, and water feeding to the second component is then controlled. Thus, simultaneous water feeding to the first component and the second component cannot be achieved, affecting simultaneous use of the first component and the second component, which in turn reduces operating efficiency of the cleaning assembly.

One of the first component and the second component according to the embodiments of the present disclosure is the floor cleaning component, and another one is the clothes cleaning component. The water feeding to the clothes cleaning component is less affected due to a short water feeding time of the floor cleaning component. Moreover, the floor cleaning component has a small water volume need, during simultaneous water feeding to the floor cleaning component and the clothes cleaning component, the floor cleaning component has small influence on the water feeding to the clothes cleaning component due to a small water feeding volume of the floor cleaning component. Therefore, in the embodiments of the present disclosure, water feeding to the first component as well as water feeding to the second component can be simultaneously controlled when the first component and the second component request the water feeding simultaneously. Thus, when each of the first component and the second component has a demand for the water feeding, an overall time for the water feeding can be shortened, thereby improving the operating efficiency of the cleaning assembly.

In another exemplary embodiment of the present disclosure, each of the first component and the second component of the cleaning assembly includes a water inlet valve. Further, determining that the first component is in the water feeding state, and controlling water feeding to the second component based on a water feeding request for the second component includes: determining that the first component is in the water feeding state, and based on the water feeding request for the second component, controlling the water inlet valve of the first component to open to feed water to the first component through a first passage of a three-way passage structure, and controlling the water inlet valve of the second component to open to feed water to the second component through a second passage of the above-mentioned three-way passage structure.

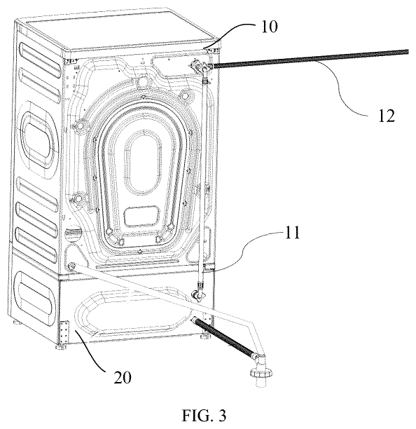

In an exemplary embodiment of the present disclosure, FIG. 3 is a schematic rear structural view of the cleaning assembly illustrated in FIG. 2 according to an embodiment of the present disclosure, in which a three-way passage structure for feeding water may be provided at the cleaning assembly. A faucet is connected to the three-way passage structure through an end of a second pipe 12. The three-way passage structure has a first water outlet connected to a water inlet of the floor cleaning component 20 by a first pipe 11, and a second water outlet connected to a water inlet of the clothes cleaning component 10.

As illustrated in FIG. 3, the water inlet valve of the floor cleaning component 20 may be provided at the first pipe 11 or at a connection between the first pipe 11 and the floor cleaning component 20. When water feeding to the floor cleaning component 20 is needed, the water inlet valve of the floor cleaning component 20 is controlled to open, and water flowing through the faucet flows out through the first water outlet of the three-way passage structure and passes through the first pipe 11 to be fed to the floor cleaning component 20. The water inlet valve of the clothes cleaning component 10 may be provided at the second pipe 12 or at a connection between the second pipe 12 and the clothes cleaning component 10. When water feeding to the clothes cleaning component 10 is needed, the water inlet valve of the clothes cleaning component 10 is controlled to open, and the water flowing through the faucet flows out through the second water outlet of the three-way passage structure and to be fed to the clothes cleaning component 10.

As a result, the first component and the second component having the cleaning function can share water from one water source, and thus it is not necessary for the floor cleaning component to be provided with a separate pipe connector to the water source. In this way, a user's modification of a water source pipeline is eliminated, and use cost is lowered.

In another exemplary embodiment of the present disclosure, controlling the water inlet valve of the first component to open may include: controlling the water inlet valve of the first component to open, and adjusting an opening degree of the water inlet valve of the first component to control a flow rate of water fed to the first component.

Controlling the water inlet valve of the second component to open may include: controlling the water inlet valve of the second component to open, and adjusting an opening degree of the water inlet valve of the second component to control a flow rate of water fed to the second component.

In an exemplary embodiment of the present disclosure, the water inlet valve of the first component and the water inlet valve of the second component may, for example, be a flow limit valve having a flow limit function. Exemplarily, when a flow speed of water flowing through the water inlet valve of the first component is greater than a first water flow speed, the water inlet valve of the first component is controlled to close, or the opening degree of the water inlet valve of the first component is reduced, thereby controlling a decrease in an opening degree of water feeding to the first component. When a flow speed of water flowing through the water inlet valve of the second component is greater than a second water flow speed, the water inlet valve of the second component is controlled to close, or the opening degree of the water inlet valve of the second component is reduced, thereby controlling a decrease in an opening degree of water feeding to the second component. As a result, a problem of splashing of the water flow due to an excessive flow speed of water flowing through the first component and the second component can be avoided.

In an exemplary embodiment of the present disclosure, the floor cleaning component may include a base station water tank, a movable member water tank, and a base station washing tank. Further, determining that the clothes cleaning component is in the water feeding state, and controlling water feeding to the floor cleaning component based on a water feeding request for the floor cleaning component further includes: controlling the base station water tank of the floor cleaning component to feed water to the movable member water tank of the floor cleaning component; or controlling the base station water tank of the floor cleaning component to feed water to the base station washing tank of the floor cleaning component; or controlling the base station water tank of the floor cleaning component to feed water to the movable member water tank and the base station washing tank of the floor cleaning component simultaneously.

In an exemplary embodiment of the present disclosure, the floor cleaning component may include a base station and a movable cleaning member. The base station includes a base station water tank and a base station washing tank, and the movable cleaning member includes a movable member water tank. The movable cleaning member may be a robotic sweeper. When water feeding to the floor cleaning component is needed, after controlling the water feeding to the floor cleaning component, the base station water tank of the floor cleaning component may be controlled to feed water to the base station washing tank of the floor cleaning component. After feeding water to the base station washing tank, the base station washing tank can clean a cleaning member of the movable cleaning member that has moved back to the base station. Exemplarily, when the movable cleaning member moves back to the base station after cleaning some floor regions, if the cleaning member of the movable cleaning member is dirty and is needed to be cleaned, the base station water tank can then be controlled to feed water to the base station washing tank to wash the cleaning member.

In another exemplary embodiment of the present disclosure, the floor cleaning component and/or the clothes cleaning component further includes a water flow adjustment device, such as a water flow adjustment valve. Due to a high water pressure of a municipal pipeline network, direct water feeding may cause water to splash. However, the water flow adjustment device is provided for reducing a pressure of the fed water to avoid splashing of water flowing into the floor cleaning component for example. In this case, the control method may include: obtaining a water feeding request for at least one component of the cleaning assembly, in which the cleaning assembly includes two components including a floor cleaning component and a clothes cleaning component; and determining that one of the two components of the cleaning assembly is in a water feeding state, and controlling water feeding to a water feeding adjustment apparatus of another one of the two components of the cleaning assembly based on a water feeding request for the other one of the two components.

In some embodiments, the movable cleaning member may include a movable cleaning water tank. When water feeding to the floor cleaning component is needed, after controlling the water feeding to the floor cleaning component, the base station water tank may be controlled to feed water to the movable member water tank of the floor cleaning component. Exemplarily, the movable cleaning member is provided with a movable member water tank to allow the movable cleaning member to clean a floor region with water in the movable member water tank. When a water volume of the movable member water tank decreases, the movable cleaning member moves back to the base station, and the movable member water tank is replenished by the base station water tank through water feeding. Once the water replenishment of the movable member water tank is completed, the movable cleaning member may return to continue cleaning the floor region again.

In some embodiments, in order to improve the operating efficiency, after controlling the water feeding to the floor cleaning component, when water feeding to each of the base station washing tank and the movable member water tank is needed, the base station water tank of the floor cleaning component can be controlled to feed water to the movable member water tank of the floor cleaning component while being controlled to feed water to the base station washing tank of the floor cleaning component. Therefore, the simultaneous water feeding to the base station washing tank and movable member water tank can be realized. As a result, a water feeding time is saved.

In another exemplary embodiment of the present disclosure, controlling the base station water tank of the floor cleaning component to feed water to the movable member water tank of the floor cleaning component, or controlling the base station water tank of the floor cleaning component to feed water to the base station washing tank of the floor cleaning component, or controlling the base station water tank of the floor cleaning component to feed water to the movable member water tank and the base station washing tank of the floor cleaning component simultaneously may further include: controlling water fed to the base station water tank of the floor cleaning component to reach a first threshold.

In an exemplary embodiment of the present disclosure, in order to ensure that there is a sufficient water volume of the base station water tank to be fed to the base station washing tank and the movable cleaning member, water fed to the base station water tank may be controlled to reach the first threshold before, during or after controlling the base station water tank to feed water to the base station washing tank and/or the movable member water tank. For example, the base station water tank may be provided with a water level sensor, and when the water level sensor senses that the water volume of the base station water tank reaches the first threshold, the base station water tank is controlled to feed no water.

Exemplarily, the base station water tank has a capacity of A liters, and the base station water tank may be controlled to be full of water, for example, to be fed with water of A liters of. In another exemplary embodiment of the present disclosure, the base station water tank may be controlled to not be full of water. When the base station water tank has a capacity of A liters for example, the base station water tank is fed with water of B liters, where B is smaller than A. In this way, overflowing after feeding water can be avoided. It should be noted that an exemplary first threshold may be set based on actual use needs of the floor cleaning component, which is not limited to the embodiments of the present disclosure.

In some embodiments, it is also possible to control the base station water tank to feed water to the base station washing tank while controlling the water feeding to the base station water tank. In this way, water is fed into the base station washing tank without waiting for finishing of the water feeding to the base station water tank. When water of a predetermined volume is stored in the base station water tank, the water in the base station water tank may be injected into the base station washing tank, thereby improving cleaning efficiency of the base station washing tank. Similarly, when water of a predetermined volume is stored in the base station water tank, the base station water tank may be controlled to feed water to the movable member water tank, shortening a water feeding time to the movable member water tank. In some embodiments of the present disclosure, a rate at which water is fed to the base station water tank may be set to be greater than a rate at which water is fed to the base station washing tank and/or the movable member water tank from the base station water tank.

In another exemplary embodiment of the present disclosure, the floor cleaning component may further include a base station water pump. Further, controlling the base station water tank of the floor cleaning component to feed water to the base station washing tank specifically includes: controlling the base station water pump to open, and feeding water to the base station washing tank by the base station water pump.

In an exemplary embodiment of the present disclosure, the base station water tank has a water outlet connected to the base station water pump. When the base station washing tank requires water supply from the base station water tank, the base station water pump is opened to allow a water feeding circuit between the base station water tank and the base station washing tank not to be blocked, and the base station water tank can feed water to the base station washing tank of the floor cleaning component. When the water volume of the base station washing tank reaches a predetermined water volume threshold, the base station water pump is closed to allow the water feeding circuit between the base station water tank and the base station washing tank to be blocked, and the base station water tank no longer feeds water to the base station washing tank.

In another exemplary embodiment of the present disclosure, the floor cleaning component may further include a movable member water suction pump. Further, controlling the base station water tank of the floor cleaning component to feed water to the movable member water tank specifically includes: controlling the movable member water suction pump to open, and feeding water to the movable member water tank by the movable member water suction pump.

In the related art, a solenoid valve is connected at the water outlet of the base station water tank. Further, the solenoid valve is connected to a diversion valve. The solenoid valve is configured to control blocking or unblocking of a water outflowing circuit of the base station water tank, and the diversion valve is configured to control the base station water tank to be in communication with one of a water feeding branch circuit of the base station water tank to the base station washing tank and a water feeding branch circuit of the base station water tank to the movable member water tank. Exemplarily, when the base station water tank is needed to feed water to the base station washing tank, the solenoid valve is opened and then the diversion valve is driven to rotate to allow a water inflowing branch circuit of the base station water tank to the base station washing tank to open, and water in the base station water tank thus flows to the base station washing tank by the water pump. When the base station water tank is needed to feed water to the movable member water tank, the solenoid valve is opened and then the diversion valve is driven to rotate to allow the water feeding branch circuit of the base station water tank to the movable member water tank to open, and water in the base station water tank thus flows to the movable member water tank by the water pump. As a result, since the solenoid valve and the diversion valve are both provided, simultaneous feeding water from the base station water tank to the base station washing tank and the movable member water tank cannot be implemented, thereby limiting a water inflowing rate of the floor cleaning component.

In order to solve the above-mentioned problem, the movable cleaning member is provided with a suction pump according to the embodiments of the present disclosure. When water feeding to the movable member water tank is needed from the base station water tank, the movable member suction pump is controlled to open, and the water feeding to the movable member water tank from the base station water tank is carried out by the mobile section suction pump. When the water feeding to the movable member water tank is no longer needed, the movable member suction pump is controlled to close, and no water feeding to the movable member water tank is carried out from the base station water tank.

As a result, by providing the base station water tank with the base station water pump and providing the movable cleaning member with the movable member suction pump, simultaneous water feeding to the base station washing tank and the movable member water tank can be carried out from the base station water tank, and the base station washing tank and the movable cleaning member do not interact with each other during the simultaneous water feeding, which can improve a water feeding rate of the floor cleaning component.

In some embodiments, the control method may further include, subsequent to controlling water fed to the base station water tank of the floor cleaning component to reach the first threshold: stopping the water feeding to the floor cleaning component; obtaining a current water volume of the base station water tank of the floor cleaning component; and feeding water to the base station water tank in response to determining that the current water volume is smaller than a second threshold. The second threshold is smaller than or equal to the first threshold.

In an exemplary embodiment of the present disclosure, after the water inlet valve of the floor cleaning component is closed, the current water volume of the base station water tank may be sensed in real time by using the water level sensor. If the current water volume is smaller than the second threshold, exemplarily, the current water volume is for example C liters, which is smaller than the second threshold that is D liters, which indicates that water feeding to the base station water tank is needed, then the water inlet valve of the floor cleaning component may be controlled to open to feed water to the base station water tank. If the current water volume is E liters for example, which is greater than the second threshold that is D liters, which indicates that the water feeding to the base station water tank is not needed at this time, then the water inlet valve of the floor cleaning component is not opened.

It should be noted that an exemplary second threshold may be set based on actual use needs of the floor cleaning component, as long as the second threshold satisfies that the first threshold is greater than the second threshold, which is not limited to the embodiments of the present disclosure.

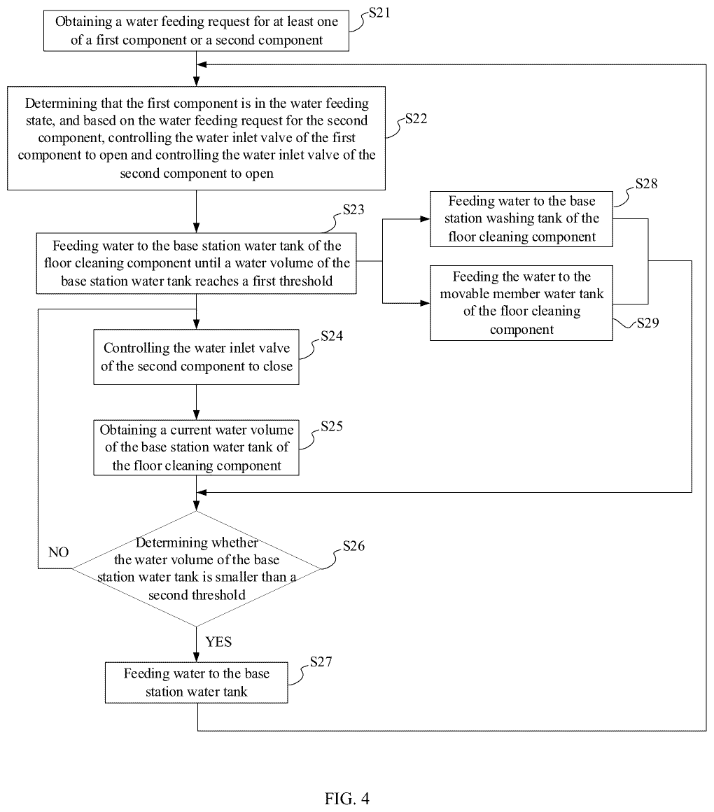

FIG. 4 is an exemplary flowchart of a control method for a cleaning assembly according to an embodiment of the present disclosure. As illustrated in FIG. 4, the control method for the cleaning assembly includes actions at blocks S21 to S29.

At block S21, a water feeding request for at least one of the first component or the second component is obtained.

At block S22, it is determined that the first component is in the water feeding state, and in response to the water feeding request for the second component, the water inlet valve of the first component and the water inlet valve of the second component are controlled to open.

At block S23, the feeding water to the base station water tank of the floor cleaning component is controlled until a water volume of the base station water tank reaches a first threshold.

At block S24, the water inlet valve of the second component is controlled to close.

At block S25, a current water volume of the base station water tank of the floor cleaning component is obtained.

At block S26, it is determined whether the water volume of the base station water tank is smaller than the second threshold; in response to the water volume of the base station water tank being smaller than the second threshold, the action at block S27 is performed; and in response to the water volume of the base station water tank being greater than or equal to the second threshold, the action at block S24 is performed.

At block S27, water is fed to the base station water tank.

After performing the action at block S27, the action at block S22 continues to be performed.

After performing the action at block S23, the control method further includes actions at blocks S28 and S29.

At block S28, water feeding to the base station washing tank of the floor cleaning component is controlled.

At block S29, water feeding to the movable member water tank of the floor cleaning component is controlled.

It should be noted that when the movable cleaning member returns to the base station after cleaning the floor region, the cleaning member of the movable cleaning member is dirty and is needed to be cleaned, and the water feeding to the movable member water tank of the mobile part is not needed, only the action at block S28 may be performed; when the water volume of the movable member water tank decreases after the movable cleaning member has cleaned the floor region, the water feeding to the movable member water tank is needed instead of cleaning the cleaning member. After the movable cleaning member returns to the base station, only the action at block S29 may be performed. In addition, when the water feeding to each of the base station washing tank and the movable member water tank is needed, the actions at blocks S28 and S29 may be performed simultaneously, which is not limited to the embodiments of the present disclosure.

It should be noted that FIG. 4 schematically shows that the second component is the floor cleaning component, and the first component may also be the floor cleaning component, which can be controlled with reference to the above-mentioned embodiments, and description thereof in detail will be omitted herein.

According to the embodiments of the present disclosure, the floor cleaning component and the clothes cleaning component are integrated into the cleaning assembly. When one of the two components of the cleaning assembly is in the water feeding state and the water feeding to the other one of the two components of cleaning assembly is needed, the impact on the water pressure is small due to the small water feeding volume of the floor cleaning component. Further, due to the short water inflowing time, in the present disclosure, the two components of the cleaning assembly can be controlled to be fed water simultaneously without affecting normal water feeding to either component. In addition, in the embodiments of the present disclosure, water feeding to the two components can be carried out simultaneously when the water feeding to each of the two components of the cleaning assembly is needed. In this way, unlike methods in the related art, it is not necessary to control the water feeding to one component after the water feeding has been carried out on the other component. Therefore, with the control method for the cleaning assembly according to the embodiments of the present disclosure, when the water feeding to each of the two components of the cleaning assembly is needed, an overall water feeding time can be shortened, thereby improving operating efficiency of the cleaning assembly.

Embodiments of the present disclosure also provide a control apparatus for a cleaning assembly. FIG. 5 is a schematic diagram of a control apparatus for a cleaning assembly according to an embodiment of the present disclosure. As illustrated in FIG. 5, a control apparatus 10 for a cleaning assembly includes an obtaining module 101 and a control module 102. The obtaining module 101 is configured to obtain a water feeding request for at least one component of the cleaning assembly. The cleaning assembly includes two components including a floor cleaning component and a clothes cleaning component. The control module 102 is configured to determine that one of the two components of the cleaning assembly is in a water feeding state, and control water feeding to another one of the two components of the cleaning assembly based on a water feeding request for the other one of the two components.

In some embodiments, the two components of the cleaning assembly includes a first component and a second component, respectively. Each of the first component and the second component includes a water inlet valve. The control module 102 is further configured to: determine that the first component is in the water feeding state, and based on the water feeding request for the second component, control the water inlet valve of the first component to open to feed water to the first component through a first passage of a three-way passage structure and control the water inlet valve of the second component to open to feed water to the second component through a second passage of the three-way passage structure.

In some embodiments, the control module 102 is further configured to: control the water inlet valve of the first component to open, and adjust an opening degree of the water inlet valve of the first component to control a flow rate of water fed to the first component. Controlling the water inlet valve of the second component to open includes: controlling the water inlet valve of the second component to open, and adjusting an opening degree of the water inlet valve of the second component to control a flow rate of the water fed to the second component.

In some embodiments, the floor cleaning component includes a base station water tank, a movable member water tank, and a base station washing tank. The control module 102 is further configured to: determine that the clothes cleaning component is in the water feeding state, and based on a water feeding request for the floor cleaning component, control the base station water tank of the floor cleaning component to feed water to the movable member water tank, and/or control the base station water tank of the floor cleaning component to feed water to the base station washing tank.

In some embodiments, the control module 102 is further configured to control water fed to the base station water tank of the floor cleaning component to reach a first threshold.

In some embodiments, the floor cleaning component further includes a movable member water suction pump. The control module 102 is further configured to control the movable member water suction pump to open, and feed water to the movable member water tank by the movable member water suction pump.

In some embodiments, the floor cleaning component further includes a base station water pump. The control module 102 is further configured to control the base station water pump to open, and feed water to the base station washing tank by the base station water pump.

In some embodiments, the control module 102 is further configured to, subsequent to controlling water fed to the base station water tank of the floor cleaning component to reach the first threshold: stop the water feeding to the floor cleaning component; obtain a current water volume of the base station water tank of the floor cleaning component; and feed water to the base station water tank in response to determining that the current water volume is smaller than a second threshold. The second threshold is smaller than or equal to the first threshold.

The control apparatus according to the above-mentioned embodiments of the present disclosure and the control method according to the embodiments of the present disclosure have the same inventive concept and beneficial effects, and thus the description thereof in detail which will be omitted herein.

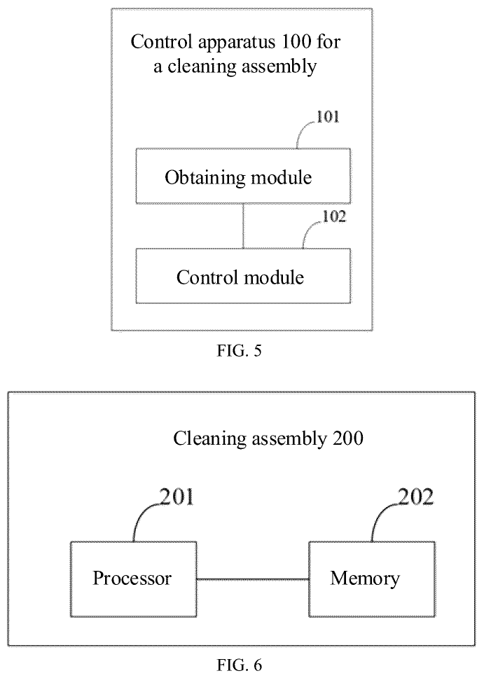

As illustrated in FIG. 6, embodiments of the present disclosure also provide a cleaning assembly 20. The cleaning assembly 20 includes a memory 201, a processor 202, and a computer program stored on the memory and executable on the processor. The processor 202 is configured to implement, when executing the computer program, the control method for the cleaning assembly according to any of the above-mentioned embodiments.

In an exemplary embodiment of the present disclosure, the cleaning assembly may include a processor, a memory, a bus, and a communication interface. The processor, the communication interface, and the memory are connected to each other via the bus. The memory has stored thereon a computer program executable on the processor. The processor is configured to implement, when executing the computer program, the control method for the cleaning assembly according to any of the above-mentioned embodiments of the present disclosure.

The memory may include a high-speed random access memory (RAM: Random Access Memory) or may also include a non-volatile memory, such as at least one disk memory. A communication connection between this system network element and at least one other network element is realized through at least one communication interface (which may be wired or wireless), which may use the Internet, a wide area network, a local area network, a metropolitan area network, etc.

The bus may be an Industry Standard Architecture, ISA, bus, a Peripheral Component Interconnect, PCI, bus or an Extended Industry Standard Architecture, EISA, bus, etc. The bus may be divided into an address bus, a data bus, a control bus, etc. The memory is configured to store a program. The processor is configured to execute, when receiving execution instructions, the program. The control method for the cleaning assembly as disclosed in any of the above-mentioned embodiments of the present disclosure may be applied in or implemented by the processor.

The processor may be an integrated circuit chip having signal processing capabilities. In an implementation, actions of the above method may be accomplished by an integrated logic circuit in hardware in the processor or by instructions in the form of software. The above processor may be a general-purpose processor, including a Central Processing Unit (CPU), a Network Processor (NP), etc.; and may further be a Digital Signal Processor (DSP), an Application Specific Integrated Circuit (ASIC), a Field-Programmable Gate Array (FPGA) or other programmable logic devices, a discrete gate or a transistor logic device, and a discrete hardware component. The method, actions, and logic block diagrams according to any of the embodiments of the present disclosure may be implemented or performed. The general-purpose processor may be a microprocessor, or the processor may further be any conventional processor, etc. The actions of the method disclosed in combination with any of the embodiments of the present disclosure may be directly embodied as performed by a hardware decoding processor or performed by a combination of a hardware module and a software module in a decoding processor. The software module may be located in a random memory, a flash memory, a read-only memory, a programmable read-only memory or an electrically erasable programmable memory, a register, and other storage media mature in the art. The storage medium is located in the memory. The processor reads information in the memory and completes the actions of the above method in combination with the hardware.

The cleaning assembly according to the embodiments of the present disclosure and the control method for the cleaning assembly according to the embodiments of the present disclosure have the same inventive concept, which has the same beneficial effects as the method employed, executing, or implemented thereby.

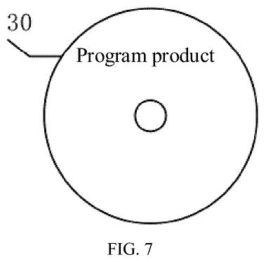

Embodiments of the present disclosure also provide a computer-readable storage medium. Referring to FIG. 7, a computer-readable storage medium illustrated in FIG. 7 is an optical disk 30. The optical disk 30 has computer-readable instructions (i.e., a program product) stored thereon. The computer-readable instructions implements, when executed by a processor, the control method for the cleaning assembly according to any of the above-mentioned embodiments.

Examples of a storage medium for a computer include, but are not limited to, a Phase-Change Memory (PRAM), a Static RAM (SRAM), a Dynamic RAM (DRAM), other types of RAMs, a Read-Only Memory (ROM), an Electrically Erasable Programmable Read-Only Memory (EEPROM), a flash memory or other memory technologies, or other optical storage, or other magnetic storage devices, which will not be repeated herein.

The computer-readable storage medium according to the above-mentioned embodiments of the present disclosure and the control method for the cleaning assembly according to the embodiments of the present disclosure have the same inventive concept, which has the same beneficial effects as the method employed, run or realized by the application stored therein.

It should be noted that a large number of specific details are described in the specification provided herein. However, it can be understood that the embodiments of the present disclosure can be practiced without these specific details. In some examples, methods, structures, and techniques that are publicly known are not shown in detail for no vague understanding of the present specification.

Similarly, it should be understood that, in order to streamline the present disclosure and aid in understanding one or more of the various inventive aspects, in the description of exemplary embodiments of the present disclosure above, the various features of the present disclosure are sometimes grouped together in individual embodiments, figures, or descriptions thereof. However, the disclosed method should not be construed as reflecting an intent that the present disclosure claimed for protection requires more features than those expressly documented in each claim. More precisely, as reflected in the claims below, the inventive aspects lie in fewer than all of the features of the individual embodiments disclosed earlier. Accordingly, the claims that follow a specific embodiment are thereby expressly incorporated into that specific embodiment, with each claim itself serving as a separate embodiment of the present disclosure.

Those skilled in the art will understand that the modules in the apparatus of an embodiment can be adaptively changed and provided in one or more apparatuses different from that embodiment. The modules or units or components of the embodiments can be combined into a single module or unit or component, as well as can be divided into a plurality of sub-modules or sub-units or sub-assemblies. Any combination of all features disclosed in this specification (including accompanying claims, an abstract, and accompanying drawings) and all processes or units of any method or apparatus so disclosed may be employed, except that at least some of such features and/or processes or units are mutually exclusive. Unless otherwise expressly stated, each feature disclosed in this specification (including the accompanying claims, abstract, and accompanying drawings) may be replaced by an alternative feature that provides the same, equivalent, or similar purpose.

In addition, those skilled in the art can understand that although some embodiments described herein include some features included in other embodiments but not others, combinations of features from different embodiments are meant to be within the scope of the present disclosure and form different embodiments. For example, in the following claims, any one of the embodiments claimed for protection may be used in any combination.

Various component embodiments of the present disclosure may be implemented in hardware, or in software modules executing on one or more processors, or a combination thereof. Those skilled in the art should understand that a microprocessor or digital signal processor (DSP) may be used in practice to implement some or all of the functionality of some or all of the components of a creation device for a virtual machine according to embodiments of the present disclosure. The present disclosure may also be implemented as an apparatus or device program (e.g., a computer program and a computer program product) for performing some or all of the methods described herein. Such a program implementing the present disclosure may be stored on a computer-readable medium or may have the form of one or more signals. Such signals may be available for download from an Internet site, or provided on a carrier signal, or in any other form.

It should be noted that the above-mentioned embodiments are for illustrating the present disclosure rather than limiting the present disclosure, and those skilled in the art may devise replacement embodiments without departing from the scope of the appended claims. In the claims, any reference between parentheses should not be construed as a limitation of the claims. The word “comprising” does not exclude the existence of elements or steps not listed in the claims. The word “one” or “a” before an element does not exclude the existence of a plurality of such elements. The present disclosure may be implemented with the aid of hardware comprising a number of different elements and with the aid of a suitably programmed computer. In unit claims enumerating a number of devices, several of these devices may be specified by means of the same hardware item. The use of the words first, second, and third, etc. does not indicate any order. The words may be construed as names.

The above-mentioned embodiments are merely exemplary embodiments of the present disclosure, and are not intended to limit the scope of the present disclosure. Any structural modifications made by one skilled in the art based on the contents of the specification of the present disclosure and the accompanying drawings, or any direct or indirect application of the present disclosure in other relevant technical fields are also fall within the scope of the present disclosure.

1-10. (canceled)

11. A control apparatus comprising:
an obtaining module configured to obtain a water feeding request for each of at least one of two components of a cleaning assembly, the two components including a floor cleaning component and a clothes cleaning component, and the floor cleaning component including a base station water tank, a movable member water tank, and a base station washing tank; and
a control module configured to:
determine that one of the two components is in a water feeding state; and
control water feeding to another one of the two components based on a water feeding request for the another one of the two components, including:
in response to the one of the two components in the water feeding state being the clothes cleaning component, controlling water feeding to the floor cleaning component based on a water feeding request for the floor cleaning component, including at least one of:
controlling the base station water tank of the floor cleaning component to feed water to the movable member water tank; or
controlling the base station water tank of the floor cleaning component to feed water to the base station washing tank.

12. The control apparatus according to claim 11, wherein:
the two components include a first component and a second component, each of the first component and the second component including a water inlet valve; and
the control module is further configured to:
determine that the first component is in the water feeding state; and
control water feeding to the second component based on a water feeding request for the second component, including, based on the water feeding request for the second component:
controlling the water inlet valve of the first component to open to feed water to the first component through a first passage of a three-way passage structure; and
controlling the water inlet valve of the second component to open to feed water to the second component through a second passage of the three-way passage structure.

13. The control apparatus according to claim 12, wherein the control module is further configured to:
control the water inlet valve of the first component to open, and adjust an opening degree of the water inlet valve of the first component to control a flow rate of water fed to the first component; and
control the water inlet valve of the second component to open, and adjust an opening degree of the water inlet valve of the second component to control a flow rate of water fed flow to the second component.

14. The control apparatus according to claim 11, wherein the control module is further configured to:
control water fed to the base station water tank of the floor cleaning component to reach a threshold.

15. The control apparatus according to claim 11, wherein:
the threshold is a first threshold; and
the control module is further configured to, after controlling water fed to the base station water tank of the floor cleaning component to reach the first threshold:
stop the water feeding to the floor cleaning component;
obtain a current water volume of the base station water tank of the floor cleaning component; and
feed water to the base station water tank in response to determining that the current water volume is smaller than a second threshold, the second threshold being smaller than or equal to the first threshold.

16. The control apparatus according to claim 11, wherein:
the floor cleaning component further includes a movable member water suction pump; and
the control module is further configured to:
control the movable member water suction pump to open, and feed water to the movable member water tank through the movable member water suction pump.

17. The control apparatus according to claim 11, wherein:
the floor cleaning component further includes a base station water pump; and
the control module is further configured to:
control the base station water pump to open, and feed water to the base station washing tank by the base station water pump.

18. A cleaning assembly comprising:
a processor; and
a memory storing a computer program that, when executed by the processor, causes the processor to:
obtain a water feeding request for each of at least one of two components of the cleaning assembly, the two components including a floor cleaning component and a clothes cleaning component, and the floor cleaning component including a base station water tank, a movable member water tank, and a base station washing tank;
determine that one of the two components is in a water feeding state; and
control water feeding to another one of the two components based on a water feeding request for the another one of the two components, including:
in response to the one of the two components in the water feeding state being the clothes cleaning component, controlling water feeding to the floor cleaning component based on a water feeding request for the floor cleaning component, including at least one of:
controlling the base station water tank of the floor cleaning component to feed water to the movable member water tank; or
controlling the base station water tank of the floor cleaning component to feed water to the base station washing tank.

19. The cleaning assembly according to claim 18, wherein:
the two components include a first component and a second component, each of the first component and the second component including a water inlet valve; and
the computer program further causes the processor to:
determine that the first component is in the water feeding state; and
control water feeding to the second component based on a water feeding request for the second component, including, based on the water feeding request for the second component:
controlling the water inlet valve of the first component to open to feed water to the first component through a first passage of a three-way passage structure; and
controlling the water inlet valve of the second component to open to feed water to the second component through a second passage of the three-way passage structure.

20. The cleaning assembly according to claim 19, wherein the computer program further causes the processor to:
control the water inlet valve of the first component to open, and adjust an opening degree of the water inlet valve of the first component to control a flow rate of water fed to the first component; and
control the water inlet valve of the second component to open, and adjust an opening degree of the water inlet valve of the second component to control a flow rate of water fed flow to the second component.

21. The cleaning assembly according to claim 18, wherein the computer program further causes the processor to:
control water fed to the base station water tank of the floor cleaning component to reach a threshold.

22. The cleaning assembly according to claim 18, wherein:
the threshold is a first threshold; and
the computer program further causes the processor to, after controlling water fed to the base station water tank of the floor cleaning component to reach the first threshold:
stop the water feeding to the floor cleaning component;
obtain a current water volume of the base station water tank of the floor cleaning component; and
feed water to the base station water tank in response to determining that the current water volume is smaller than a second threshold, the second threshold being smaller than or equal to the first threshold.

23. The cleaning assembly according to claim 18, wherein:
the floor cleaning component further includes a movable member water suction pump; and
the computer program further causes the processor to:
control the movable member water suction pump to open, and feed water to the movable member water tank through the movable member water suction pump.

24. The control apparatus according to claim 18, wherein:
the floor cleaning component further includes a base station water pump; and
the computer program further causes the processor to:
control the base station water pump to open, and feed water to the base station washing tank by the base station water pump.

25. A non-transitory computer-readable storage medium storing computer-readable instructions that, when executed by a processor, causes the processor to:
obtain a water feeding request for each of at least one of two components of a cleaning assembly, the two components including a floor cleaning component and a clothes cleaning component, and the floor cleaning component including a base station water tank, a movable member water tank, and a base station washing tank;
determine that one of the two components is in a water feeding state; and
control water feeding to another one of the two components based on a water feeding request for the another one of the two components, including:
in response to the one of the two components in the water feeding state being the clothes cleaning component, controlling water feeding to the floor cleaning component based on a water feeding request for the floor cleaning component, including at least one of:
controlling the base station water tank of the floor cleaning component to feed water to the movable member water tank; or
controlling the base station water tank of the floor cleaning component to feed water to the base station washing tank.

26. The storage medium according to claim 25, wherein:
the two components include a first component and a second component, each of the first component and the second component including a water inlet valve; and
the instructions further cause the processor to:
determine that the first component is in the water feeding state; and
control water feeding to the second component based on a water feeding request for the second component, including, based on the water feeding request for the second component:
controlling the water inlet valve of the first component to open to feed water to the first component through a first passage of a three-way passage structure; and
controlling the water inlet valve of the second component to open to feed water to the second component through a second passage of the three-way passage structure.

27. The storage medium according to claim 26, wherein the instructions further cause the processor to:
control the water inlet valve of the first component to open, and adjust an opening degree of the water inlet valve of the first component to control a flow rate of water fed to the first component; and
control the water inlet valve of the second component to open, and adjust an opening degree of the water inlet valve of the second component to control a flow rate of water fed flow to the second component.

28. The storage medium according to claim 25, wherein the instructions further cause the processor to:
control water fed to the base station water tank of the floor cleaning component to reach a threshold.

29. The storage medium according to claim 25, wherein:
the threshold is a first threshold; and
the instructions further causes the processor to, after controlling water fed to the base station water tank of the floor cleaning component to reach the first threshold:
stop the water feeding to the floor cleaning component;
obtain a current water volume of the base station water tank of the floor cleaning component; and
feed water to the base station water tank in response to determining that the current water volume is smaller than a second threshold, the second threshold being smaller than or equal to the first threshold.

30. The storage medium according to claim 25, wherein:
the floor cleaning component further includes a movable member water suction pump; and
the instructions further causes the processor to:
control the movable member water suction pump to open, and feed water to the movable member water tank through the movable member water suction pump.
